(19) United States
(12) Patent Application Publication
(10) Pub. No.: US 2014/0320136 A1
(43) Pub. Date: Oct. 30, 2014

(54) METHOD OF TESTING ORGANIC LIGHT-EMITTING DISPLAY PANEL, MOTHER SUBSTRATE TESTING APPARATUS, AND METHOD OF TESTING MOTHER SUBSTRATE

(71) Applicant: Samsung Display Co., Ltd., Yongin-City (KR)

(72) Inventor: Young-Min Cho, Yongin-City (KR)

(21) Appl. No.: 14/072,554

(22) Filed: Nov. 5, 2013

(30) Foreign Application Priority Data
Apr. 25, 2013 (KR) 10-2013-0046209

(51) Int. Cl. G09G 3/00

(52) U.S. Cl. CPC G09G 3/006
USPC 324/414

(57) ABSTRACT

A method of testing an organic light-emitting display panel, a mother substrate testing apparatus, and a method of testing a mother substrate are provided. The method of testing an organic light-emitting display panel includes operations of applying an electric field to an encapsulation layer of the organic light-emitting display panel and determining a defect of the organic light-emitting display panel.

### CLAIM OF PRIORITY

This application makes reference to, incorporates into this specification the entire contents of, and claims all benefits accruing under 35 U.S.C. §119 from an application earlier filed in the Korean Intellectual Property Office on Apr. 25, 2013, and there duly assigned Serial No. 10-2013-0046209.

### BACKGROUND OF THE INVENTION

1. Field of the Invention

The present invention relates to a method of testing an organic light-emitting display panel, a mother substrate testing apparatus, and a method of testing a mother substrate, and more particularly, to a method of testing reliability of an organic light-emitting display panel, and a testing apparatus.

2. Description of the Related Art

An organic light-emitting display apparatus does not require a separate light source, and thus, may operate with a low voltage and be light-weight and slim. Also, the organic light-emitting display apparatus is expected to become a next generation display apparatus due to its high quality characteristics such as a wide viewing angle, a high contrast, and a fast response time.

The organic light-emitting display apparatus deteriorates due to exterior moisture or oxygen; thus, in order to protect an organic light-emitting device, the organic light-emitting device is encapsulated. In order to ensure slimness and/or flexibility of the organic light-emitting display apparatus, a thin film encapsulation structure including a plurality of layers of a plurality of inorganic layers and/or organic layers is used to encapsulate the organic light-emitting device.

### SUMMARY OF THE INVENTION

The present invention provides a method of testing reliability of an organic light-emitting display panel.

The present invention also provides a method of testing reliability of a mother substrate including a plurality of organic light-emitting display panels, and a mother substrate testing apparatus therefor.

According to an aspect of the present invention, there is provided a method of testing an organic light-emitting display panel. The method includes operations of applying an electric field to an encapsulation layer of the organic light-emitting display panel and determining a defect of the organic light-emitting display panel.

The operation of applying the electric field may include operations of allowing a conducting plate to contact a top surface of the encapsulation layer and applying a bias voltage between a common electrode of the organic light-emitting display panel and the conducting plate.

The method may further include an operation of aging the organic light-emitting display panel.

The operation of determining the defect may include operations of turning on the organic light-emitting display panel; and checking whether a dark spot has occurred.

The encapsulation layer may be a thin film encapsulation (TFE) layer.

According to another aspect of the present invention, there is provided a mother substrate testing apparatus for testing a mother substrate on which a plurality of organic light-emitting display panels are formed. The mother substrate testing apparatus includes a base plate fixing and supporting the mother substrate, a signal supply unit including a plurality of electrode pins and providing electric signals to a pad unit of the mother substrate, and a conducting plate contacting a top surface of the mother substrate. A bias voltage is supplied to the mother substrate via at least one electrode pin of the plurality of electrode pins and the conducting plate so as to apply an electric field to encapsulation layers of the plurality of organic light-emitting display panels.

The conducting plate may be connected to a ground voltage source, and the at least one electrode pin may provide a negative bias voltage to a wiring that is commonly connected to common electrodes of the plurality of organic light-emitting display panels.

The conducting plate may include a thin-film conductive tape.

The conducting plate may include a plurality of conducting units that correspond to display units of the plurality of organic light-emitting display panels, and an insulating unit that is disposed between the plurality of conducting units and has a lattice form.

The mother substrate testing apparatus may further include a pressing unit that presses the conducting plate so as to allow the conducting plate to be tightly attached to the encapsulation layers.

After the bias voltage is supplied, voltages may be supplied to the mother substrate via the plurality of electrode pins so as to age the plurality of organic light-emitting display panels.

The mother substrate testing apparatus may further include a heater that is combined with the base plate and that provides heat to the mother substrate.

According to another aspect of the present invention, there is provided a method of testing a mother substrate. The method includes operations of providing the mother substrate on which a plurality of organic light-emitting display panels are formed to a base plate, applying an electric field to encapsulation layers of the plurality of organic light-emitting display panels, and determining organic light-emitting display panels having a defect from among the plurality of organic light-emitting display panels.

The operation of applying the electric field may include operations of allowing a conducting plate to contact a top surface of the mother substrate and applying a bias voltage between the conducting plate and a wiring that is from among wirings of the mother substrate and that is electrically connected with common electrodes of the plurality of organic light-emitting display panels.

The method may further include an operation of aging the plurality of organic light-emitting display panels.

The operation of aging may include operations of supplying heat to the base plate via a heater that is combined with the base plate and providing an aging signal to the plurality of organic light-emitting display panels.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of testing an organic light-emitting display panel according to an embodiment of the present invention;

FIG. 2 is a cross-sectional view illustrating an organic light-emitting display panel;

FIG. 3 is a cross-sectional view illustrating a pixel region of the organic light-emitting display panel shown in FIG. 2;

FIG. 4 is a flowchart of a method of testing an organic light-emitting display panel;

FIG. 5 is a flowchart of an example of electric field application in the flowchart of FIG. 4, according to an embodiment of the present invention;

FIGS. 6A and 6B are oblique views sequentially illustrating a method of testing an organic light-emitting display panel;

FIG. 7 is a flowchart of a method of testing the organic light-emitting display panel, according to another embodiment of the present invention;

FIG. 8 is a front view of a mother substrate including a plurality of organic light-emitting display panels;

FIG. 9 is an oblique view of a mother substrate testing apparatus, according to an embodiment of the present invention;

FIG. 10 is a side view of the mother substrate testing apparatus of FIG. 9;

FIG. 11 is a front view of a conducting plate of FIG. 8, according to an embodiment of the present invention; and

FIG. 12 is a flowchart of a method of testing an organic light-emitting display panel, according to another embodiment of the present invention.

### DETAILED DESCRIPTION OF THE INVENTION

The invention may be embodied in many different forms, and should not be construed as being limited to the embodiments set forth herein. Thus, the invention may include all revisions, equivalents, or substitutions which are included in the concept and the technical scope related to the invention. In the following description, well-known functions or constructions are not described in detail since they would obscure the invention with unnecessary detail.

Throughout the specification, while terms “first” and “second” are used to describe various components, it will be obvious that the components are not limited to the terms “first” and “second”. The terms “first” and “second” are used only to distinguish between each component.

Furthermore, all examples and conditional language recited herein are to be construed as being not limited to such specifically recited examples and conditions. Throughout the specification, a singular form may include plural forms, unless there is a particular description contrary thereto. Also, terms such as “comprise” or “comprising” are used to specify the existence of a recited form, a number, a process, an operations, a component, and/or groups thereof, but do not exclude the existence of one or more other recited forms, one or more other numbers, one or more other processes, one or more other operations, one or more other components and/or groups thereof.

Hereinafter, the present invention will be described in detail by explaining exemplary embodiments of the present invention with reference to the attached drawings.

As used herein, the term “and/or” includes any and all combinations of one or more of the associated listed items. Expressions such as “at least one of,” when preceding a list of elements, modify the entire list of elements and do not modify the individual elements of the list.

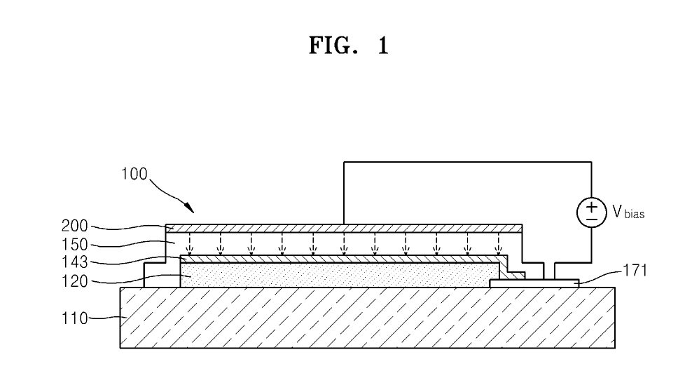

FIG. 1 illustrates a method of testing an organic light-emitting display panel 100 according to an embodiment of the present invention.

Referring to FIG. 1, the organic light-emitting display panel 100 may include a substrate 110, a display unit 120 formed on the substrate 110, and an encapsulation layer 150 for encapsulating the display unit 120. The encapsulation layer 150 entirely surrounds the display unit 120 and protects the display unit 120 from the outside.

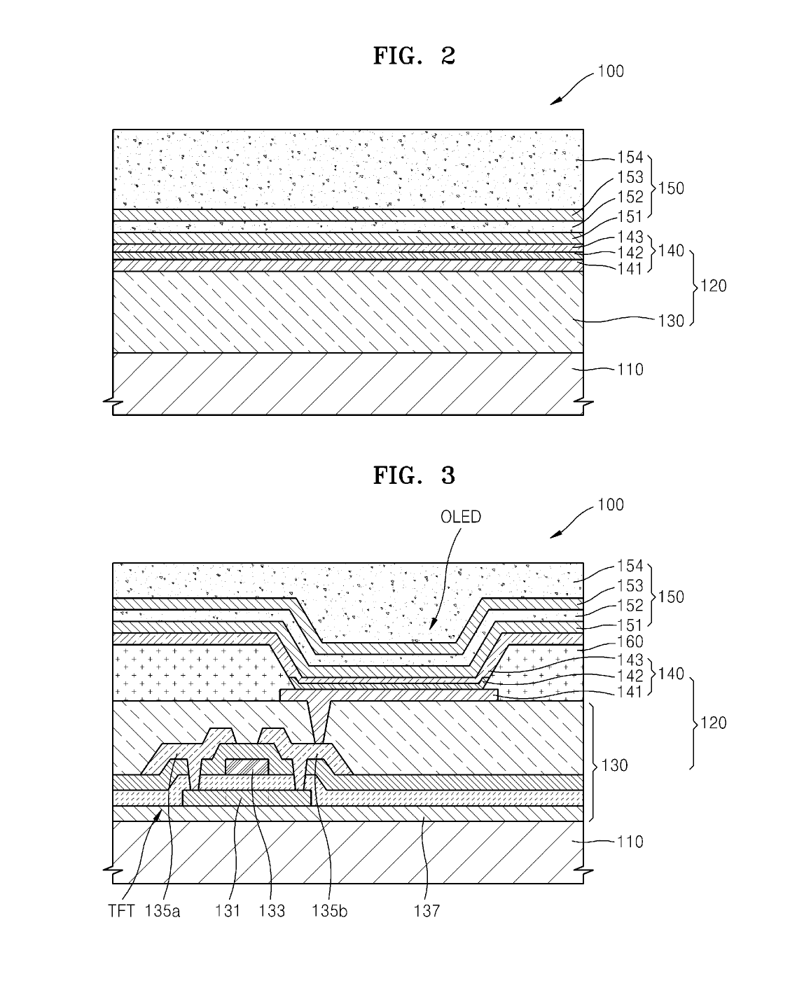

The display unit 120 may have a common electrode 143 that contacts a bottom surface of the encapsulation layer 150. As illustrated in FIG. 1, the common electrode 143 may be formed on an entire portion of a top surface of the display unit 120 and may be electrically connected with a pad 171 that is externally exposed. That is, the common electrode 143 may cover a plurality of pixels of the organic light-emitting display panel 100. A voltage may be applied to the common electrode 143 via the pad 171. The organic light-emitting display panel 100 will be described in detail later with reference to FIGS. 2 and 3.

According to the method of testing the organic light-emitting display panel 100, a strong electric field is applied to an entire portion of the encapsulation layer 150, so that a defect such as a dark spot may be found early. Here, in order to form the electric field at the encapsulation layer 150, a bias voltage Vbias may be applied between top and bottom surfaces of the encapsulation layer 150. The top surface of the encapsulation layer 150 contacts the display unit 120, and the bottom surface of the encapsulation layer 150 is externally exposed. Here, the common electrode 143 is formed below the encapsulation layer 150 but no electrode is formed on the encapsulation layer 150. Thus, in order to apply a voltage to the top surface of the encapsulation layer 150, a conducting plate 200 may be separately used. The conducting plate 200 may contact the top surface of the encapsulation layer 150, and the bias voltage Vbias may be applied between the conducting plate 200 and the common electrode 143. Accordingly, the strong electric field may be formed over an entire portion of the encapsulation layer 150.

An organic light-emitting device that is included in the organic light-emitting display panel 100 deteriorates due to exterior moisture, oxygen, or the like. Thus, in order to protect the organic light-emitting device against the exterior moisture, oxygen, or the like, the organic light-emitting device is encapsulated by the encapsulation layer 150. However, when the encapsulation layer 150 is unstably formed, the encapsulation layer 150 is gradually damaged over time, such that a progressive dark spot may occur in the organic light-emitting display panel 100.

According to the method of testing the organic light-emitting display panel 100, reliability of the organic light-emitting display panel 100 is tested. That is, by applying the strong electric field to the encapsulation layer 150 of the organic light-emitting display panel 100, the progressive dark spot may be found early in the organic light-emitting display panel 100 including the encapsulation layer 150 having less stability. Accordingly, a reliability testing time may be reduced, and the organic light-emitting display panel 100 that includes the encapsulation layer 150 having less stability may be appropriately dealt with.

FIG. 2 is a cross-sectional view illustrating the organic light-emitting display panel 100, and FIG. 3 is a cross-sectional view illustrating a pixel region of the organic light-emitting display panel 100 shown in FIG. 2.

Referring to FIGS. 2 and 3, the organic light-emitting display panel 100 includes the substrate 110, the display unit 120 formed on the substrate 110, and the encapsulation layer 150 formed on the display unit 120.

The substrate 110 may be a flexible substrate and may be formed of a plastic material such as polyimide, polyethylene terephthalate (PET), polycarbonate, polyethylene naphtalate, polyarylate (PAR), or polyetherimide that have excellent heat-resistance and durability. Alternatively, the substrate 110 may be formed of various materials including metal, glass, or the like.

The display unit 120 may be disposed on a top surface of the substrate 110. Throughout the specification, the term ‘display unit 120’ collectively refers to an organic light-emitting device OLED and a thin-film transistor (TFT) array for driving the organic light-emitting device OLED, and collectively indicates a portion for displaying an image and a driving portion for displaying the image.

The display unit 120 has a structure in which a plurality of pixels are arrayed in a matrix. Each of the pixels includes the organic light-emitting device OLED and an electronic device that is electrically connected with the organic light-emitting device OLED. The electronic device may include at least two TFTs including a driving TFT and a switching TFT, a storage capacitor, or the like. The electronic device is electrically connected with the organic light-emitting device OLED by wiring and then receives an electric signal from an external driving unit, so that the electronic device is driven. An array of the electronic device that is electrically connected with the organic light-emitting device OLED, and the wiring are referred to as the TFT array.

The display unit 120 includes a device/wiring layer 130 including the TFT array, and an organic light-emitting device layer 140 including an organic light-emitting device array. While FIG. 2 illustrates only the organic light-emitting device OLED and the TFT array that drives the organic light-emitting device OLED, this is only for convenience of description, and one or more embodiments of the present invention are not limited thereto. Thus, it will be obvious to one of ordinary skill in the art that a plurality of TFTs, storage capacitors, and various types of wiring may be further arranged.

The device/wiring layer 130 may include a driving TFT that drives the organic light-emitting device OLED, a switching TFT, a capacitor, and wiring connected with the driving TFT or the capacitor.

The driving TFT includes an active layer 131, a gate electrode 133, and source and drain electrodes 135a and 135b.

The device/wiring layer 130 may further include a buffer layer 137 that is disposed on a top surface of the substrate 110 so as to allow planarization and to prevent penetration of impurities.

The organic light-emitting device layer 140 is disposed on the device/wiring layer 130. The organic light-emitting device layer 140 includes a pixel electrode 141, an intermediate layer 142 including an emission layer (EML) that is formed on the pixel electrode 141, and the common electrode 143 disposed on the intermediate layer 142.

The pixel electrode 141 is formed as an anode, and the common electrode 143 is formed as a cathode. However, according to a method of driving the organic light-emitting display panel 100, the pixel electrode 141 may be formed as a cathode, and the common electrode 143 may be formed as an anode.

A hole and an electron that are from the pixel electrode 141 and the common electrode 143, respectively, are injected into the EML that is included in the intermediate layer 142, and then an exciton that is combination of the injected hole and electron turns to a ground state from an excited state, thereby emitting light. The common electrode 143 may emit blue light, green light, red light, or white light.

The pixel electrode 141 is electrically connected with the driving TFT that is formed at the device/wiring layer 130. The pixel electrode 141 may be a reflective electrode, and may include a reflection layer and a transparent or translucent electrode layer that is formed on the reflection layer.

The common electrode 143 that faces the pixel electrode 141 may be a transparent or translucent electrode. Thus, the common electrode 143 may transmit light that is emitted from the EML included in the intermediate layer 142.

The EML may be formed of a small-molecule organic material or a polymer organic material, and the intermediate layer 142 may selectively further include functional layers such as a hole transport layer (HTL), a hole injection layer (HIL), an electron transport layer (ETL), an electron injection layer (EIL) or the like, in addition to the EML.

In order to cover the display unit 120, the encapsulation layer 150 may be disposed on the substrate 110. The organic light-emitting device OLED included in the display unit 120 may easily deteriorate due to exterior moisture or oxygen. Thus, in order to protect the display unit 120, it is required to encapsulate the display unit 120. The encapsulation layer 150 may be a thin film encapsulation (TFE) layer having a structure in which a plurality of inorganic layers and organic layers are alternately stacked to encapsulate the display unit 120.

The encapsulation layer 150 may include inorganic layers 151 and 153, and organic layers 152 and 154. The inorganic layers 151 and 153 and the organic layers 152 and 154 may be alternately stacked.

The inorganic layers 151 and 153 may be formed of metal oxide, metal nitride, metal carbide, or a combination thereof. In the present embodiment, the inorganic layers 151 and 153 may be formed of aluminum oxide, silicon oxide, or silicon nitride. In another embodiment, the inorganic layers 151 and 153 may include a structure in which a plurality of inorganic insulating layers are stacked. The inorganic layers 151 and 153 may prevent exterior moisture and/or exterior oxygen from penetrating into the organic light-emitting device layer 140. The organic layers 152 and 154 may be formed of a polymer organic compound. The organic layers 152 and 154 may lessen an internal stress of the inorganic layers 151 and 153, or may compensate for a defect of the inorganic layers 151 and 153 and may planarize the inorganic layers 151 and 153.

In the organic light-emitting display panel 100, the substrate 110 may be formed of a flexible substrate, and the encapsulation layer 150 may be formed as the TFE layer that is formed by alternately stacking the inorganic layers 151 and 153 and the organic layers 152 and 154, so that flexibility and slimness of the organic light-emitting display panel 100 may be easily achieved. However, when the TFE layer is used, the organic light-emitting display panel 100 may be vulnerable to developing a progressive dark spot.

Here, as described above with reference to FIG. 1, according to the method of testing the organic light-emitting display panel 100, the strong electric field is applied to the encapsulation layer 150, and by doing so, the progressive dark spot may be found early.

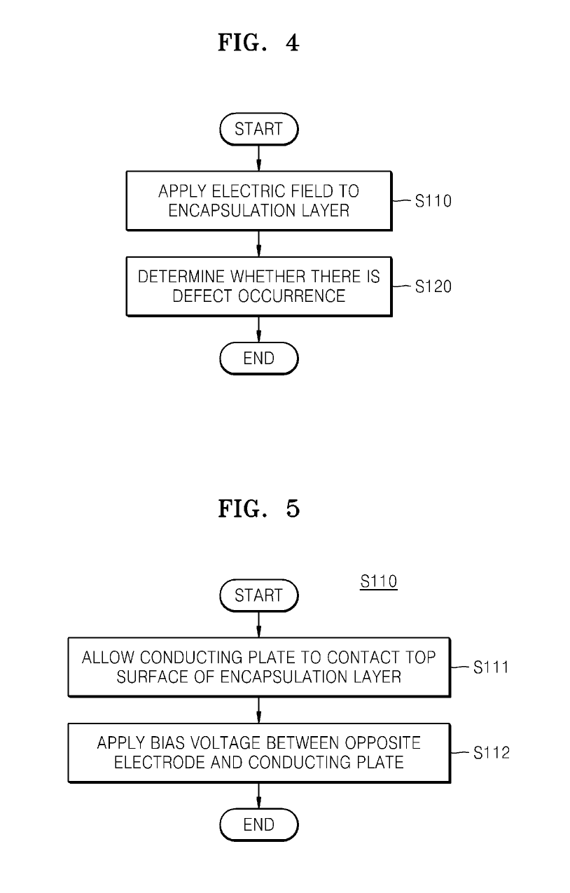

Hereinafter, with reference to FIGS. 4 through 6B, the method of testing the organic light-emitting display panel 100 will be described in detail.

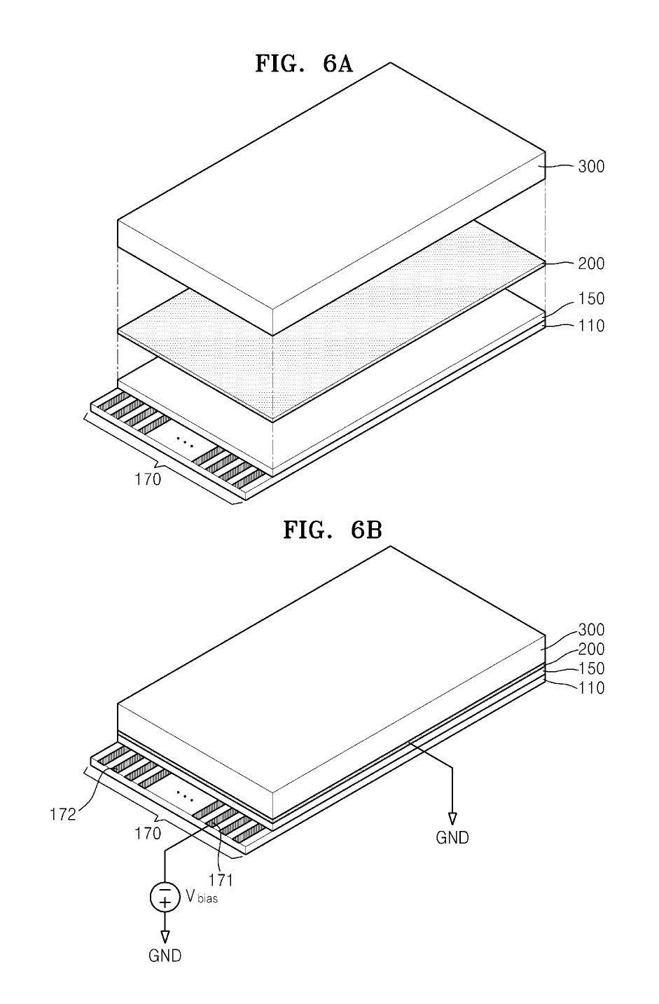

FIG. 4 is a flowchart of the method of testing the organic light-emitting display panel 100. FIG. 5 is a flowchart of an example of electric field application in the flowchart of FIG. 4, according to an embodiment of the present invention. FIGS. 6A and 6B are oblique views particularly illustrating a method of applying an electric field to the encapsulation layer 150 of the organic light-emitting display panel 100.

Referring to FIG. 4, the method of testing the organic light-emitting display panel 100 according to the present embodiment may involve applying an electric field to the encapsulation layer 150 (refer to FIG. 1) (operation S110) and determining whether there is a defect occurrence in the organic light-emitting display panel 100 (operation S120).

In the electric field application (operation S110), a bias voltage may be applied between top and bottom surfaces of the encapsulation layer 150, so that the electric field may be formed over the encapsulation layer 150. Referring to FIG. 5, in order to apply the electric field to the encapsulation layer 150, the method may involve allowing the conducting plate 200 (refer to FIG. 1) to contact the top surface of the encapsulation layer 150 (operation S111).

As illustrated in FIG. 6A, the conducting plate 200 may be a thin film tape formed of a conductive material. Also, an area of the conducting plate 200 may be similar to an area of the top surface of the encapsulation layer 150. The conducting plate 200 may be pressed toward the encapsulation layer 150 by using a pressing member 300 Pressing member means a member has a flat surface geometrically corresponding to an exterior surface of the encapsulation layer 150. The pressing member may be more rigid than the conducting plate 200 so that the conducting plate 200 may be uniformly attached to the top surface of the encapsulation layer 150 when a pressing force is applied to the pressing member 300. However, the one or more embodiments of the present invention are not limited to the use of the pressing member 300. The conducting plate 200 may have a sufficient thickness and weight, thus, the conducting plate 200 may be attached to the top surface of the encapsulation layer 150 without the use of the pressing member 300.

As illustrated in FIG. 6B, when the conducting plate 200 contacts the top surface of the encapsulation layer 150 (operation S111), the bias voltage may be applied between the conducting plate 200 and the common electrode 143 (refer to FIG. 1) that contacts the bottom surface of the encapsulation layer 150 (operation S112). Here, as illustrated in FIG. 6B, a voltage may be applied to the conducting plate 200 and the pad 171 that is electrically connected with the common electrode 143 and that is from among a plurality of pads included in a pad unit 170. Here, a ground voltage GND may be applied to the conducting plate 200, and a negative bias voltage Vbias may be applied to the pad 171 that is electrically connected with the common electrode 143. For example, the negative bias voltage Vbias may be about −30V but is not limited thereto. As long as a predetermined bias voltage may be applied between the conducting plate 200 and the pad 171, voltages having different voltage levels may be applied to the conducting plate 200 and the pad 171, respectively. For another example, the thickness of the encapsulation layer may be about 33000 Å when the bias voltage Vbias is −30V, but the bias voltage is not limited thereto. The bias voltage Vbias may comprise positive voltage level and negative voltage level and may be adjusted according to the thickness of the encapsulation layer. As the thickness of the encapsulation layer is thicker, negative voltage level of the bias voltage Vbias may be lower and positive voltage level of the bias voltage Vbias may be higher, so that stronger electric field is applied to the encapsulation layer.

In the electric field application (operation S110), an electric field may be applied to the encapsulation layer 150 during a predetermined time period. In other words, the bias voltage may be applied between common electrode 143 and the conducting plate 200 during the predetermined time period. Here, when the predetermined time period for the application of the bias voltage is increased, a possibility of finding a dark spot may be increased but a possibility of damaging the encapsulation layer 150 that is normally formed may also be increased. Thus, it is required to apply the bias voltage during an appropriate time period, according to a test condition or the like.

Referring to FIG. 4, in the defect occurrence determination (operation S120), the organic light-emitting display panel 100 may be turned on and then occurrence of the dark spot may be examined at an entire portion or a partial portion of the organic light-emitting display panel 100, so that the defect occurrence in the organic light-emitting display panel 100 may be determined

The testing of the organic light-emitting display panel 100 with reference to FIG. 4 may be performed after a characteristic test of the organic light-emitting display panel 100. After the organic light-emitting display panel 100 is manufactured, the characteristic test may be performed on a brightness characteristic, a color realization characteristic, or the like. The reliability test of FIG. 4 may be additionally performed on organic light-emitting display panels that are determined as being non-defective products via the characteristic test.

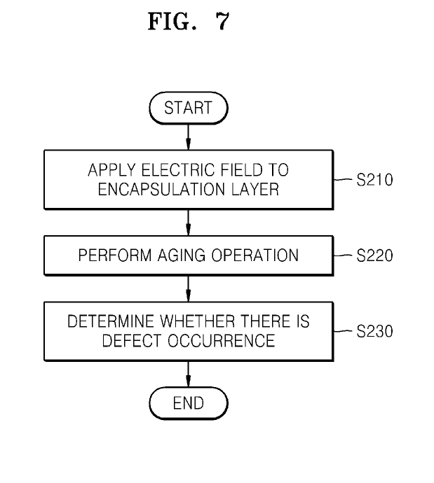

FIG. 7 is a flowchart of a method of testing the organic light-emitting display panel 100, according to another embodiment of the present invention.

Referring to FIG. 7, the method of testing the organic light-emitting display panel 100 according to the present embodiment may involve applying an electric field to the encapsulation layer 150 (operation S210), aging the organic light-emitting display panel 100 (operation S220), and determining whether there is a defect occurrence in the organic light-emitting display panel 100 (operation S230). In comparison to the method of FIG. 4, the method of FIG. 7 further involves aging the organic light-emitting display panel 100 (operation S220). Here, an aging operation involves driving an organic light-emitting device during a predetermined time period, so that the organic light-emitting device deteriorates in advance. The organic light-emitting device rapidly deteriorates in an initial driving stage, and then is stabilized at a later time. Thus, in order to prevent the quality or reliability of the organic light-emitting display panel 100 from sharply deteriorating after a product release, the aging operation may be performed. In order to perform the aging operation, driving powers and/or driving signals are provided to the organic light-emitting display panel 100. The driving powers and/or the driving signals function as aging signals. The aging signal includes a voltage or current that is supplied to a data line of each pixel so as to make a predetermined current flow in the organic light-emitting device. The driving powers and/or the driving signals may be provided from an external source via pads of the pad unit 170. In order to perform the aging operation, a positive voltage may be applied to a pad 172 that is connected with a driving power line (not shown), and a negative voltage may be applied to the pad 171 that is connected with the common electrode 143 (refer to FIG. 3). The positive voltage that is supplied via the driving power line may be applied to the pixel electrode 141 (refer to FIG. 3) of the organic light-emitting device. Accordingly, a voltage is applied between the pixel electrode 141 and the common electrode 143 of the organic light-emitting device, so that the organic light-emitting device may emit light. For example, the positive voltage may be about 4.6V, and the negative voltage may be about −10V, but are not limited thereto. A voltage that is applied to the organic light-emitting device may vary according to an aging condition. For example, the aging operation may be performed by applying a reverse bias voltage the organic light-emitting device.

According to the present embodiment, when the aging operation is performed, an aging time may be decreased by adding heat to the organic light-emitting display panel 100.

The electric field application (operation S210) and the defect occurrence determination (operation S230) are substantially the same as corresponding operations in the flowchart of FIG. 4, thus, overlapping descriptions thereof will be omitted here.

Next, a mother substrate testing apparatus, and a method of testing a mother substrate will be described below. Here, the mother substrate means a substrate on which a plurality of the organic light-emitting display panels 100 are formed.

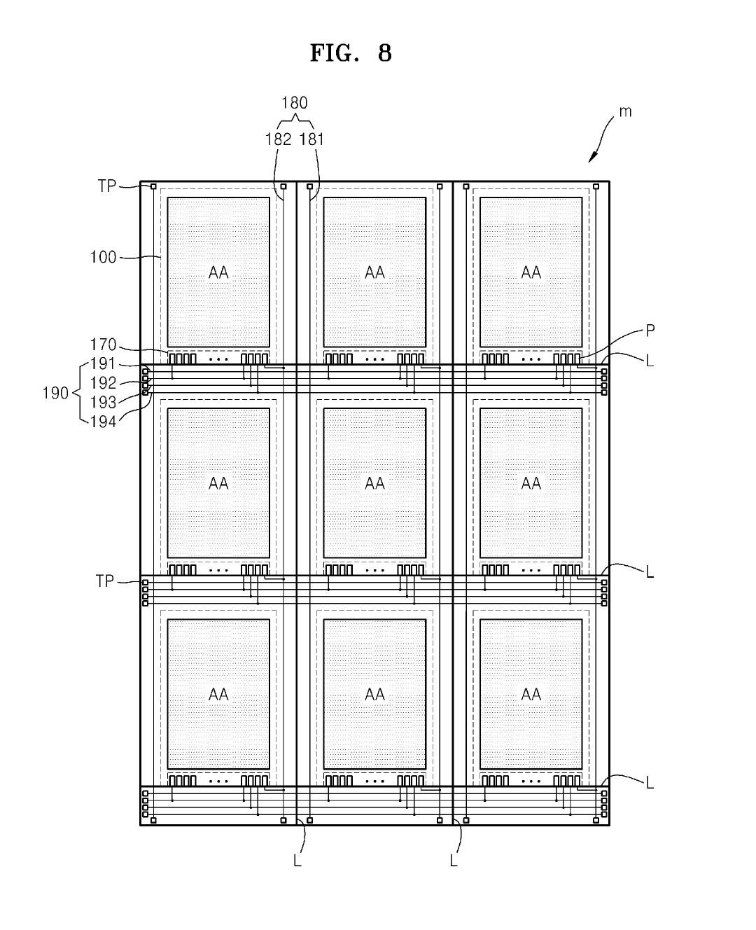

FIG. 8 is a front view of a mother substrate m including the organic light-emitting display panels 100.

Referring to FIG. 8, the mother substrate m may include a plurality of the organic light-emitting display panels 100 that are arrayed in a matrix, a first wiring group 180 that is formed in a first direction at outer regions of the organic light-emitting display panels 100, a second wiring group 190 that is formed in a second direction at the outer regions, and test pads TP that are connected to ends of wirings 181, 182, 191, 192, 193, and 194, respectively.

Referring to FIG. 8, nine organic light-emitting display panels 100 are formed at the mother substrate m, but the number of the organic light-emitting display panels 100 is not limited thereto. According to a design condition and a substrate size, the number of the organic light-emitting display panels 100 may vary.

Each of the organic light-emitting display panels 100 includes a display region AA and a pad unit 170.

The display region AA may include a pixel unit formed of the organic light-emitting device OLED and the TFT that are shown in FIG. 3, and circuits for driving and testing the pixel unit. As illustrated in FIG. 1, the display region AA may be encapsulated by the encapsulation layer 150.

The pad unit 170 includes a plurality of pads P for transferring powers and/or signals from an outer source into the organic light-emitting display panels 100.

The first wiring group 180 may be formed at the outer regions of the organic light-emitting display panel 100, e.g., the first wiring group 180 may be formed in the first direction at boundary regions between the organic light-emitting display panels 100. For example, the first direction may be a vertical direction. The first wiring group 180 includes the wirings 181 and 182 that receive powers or signals for testing from the outer source via the test pads TP. By doing so, the first wiring group 180 may simultaneously supply the powers or signals for testing from the outer source to the organic light-emitting display panels 100 that are arrayed in the first direction.

The second wiring group 190 may be formed at the outer regions of the organic light-emitting display panels 100, e.g., the second wiring group 190 may be formed in the second direction crossing the first direction at the boundary regions between the organic light-emitting display panels 100. For example, the second direction may be a horizontal direction. The second wiring group 190 includes the wirings 191, 192, 193, and 194 that receive powers or signals for testing from the outer source via the test pads TP. By doing so, the second wiring group 190 may simultaneously supply the powers or signals for testing from the outer source to the organic light-emitting display panels 100 that are arrayed in the second direction.

Referring to FIG. 8, the first wiring group 180 and the second wiring group 190 are formed in the first direction and the second direction, respectively. However, in another embodiment, the first wiring group 180 and the second wiring group 190 may be formed only in the first direction or the second direction.

The wirings 181, 182, 191, 192, 193, and 194 that are included in the first and second wiring groups 180 and 190 may be connected with the plurality of pads P of the pad unit 170, and may supply the powers or signals for testing from the outer source to the organic light-emitting display panels 100 via the test pads TP. For example, the powers for testing may include a first pixel power ELVSS and a second pixel power ELVDD, and the signals for testing may include a scan signal, an emission control signal, an aging signal, or the like.

Each of the organic light-emitting display panels 100 may receive the power or signals for testing from the outer source via the wirings 181, 182, 191, 192, 193, and 194, and then a test may proceed. For example, for a display quality test of the organic light-emitting display panel 100, the organic light-emitting display panel 100 may receive the first pixel power ELVSS, the second pixel power ELVDD, the scan signal, the emission control signal, or the like, and then may emit light during a predetermined time period in which the first pixel power ELVSS, the second pixel power ELVDD, the scan signal, the emission control signal, or the like are supplied. Also, according to the method of testing the organic light-emitting display panel 100, when an electric field is applied to the encapsulation layer 150 (refer to FIG. 1), a bias voltage may be applied to the organic light-emitting display panel 100 via a wiring that is electrically connected with the common electrode 143 (refer to FIG. 3).

When the test is completed, the mother substrate m may be cut and divided into the organic light-emitting display panels 100. Section lines L shown on the mother substrate m partition the organic light-emitting display panels 100, respectively. By scribing the section lines L, the organic light-emitting display panels 100 that are separated from each other may be finally manufactured.

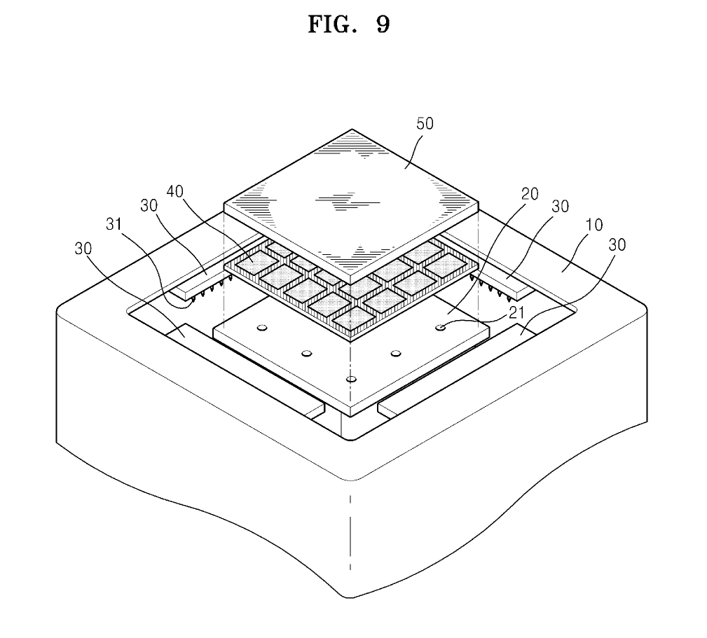

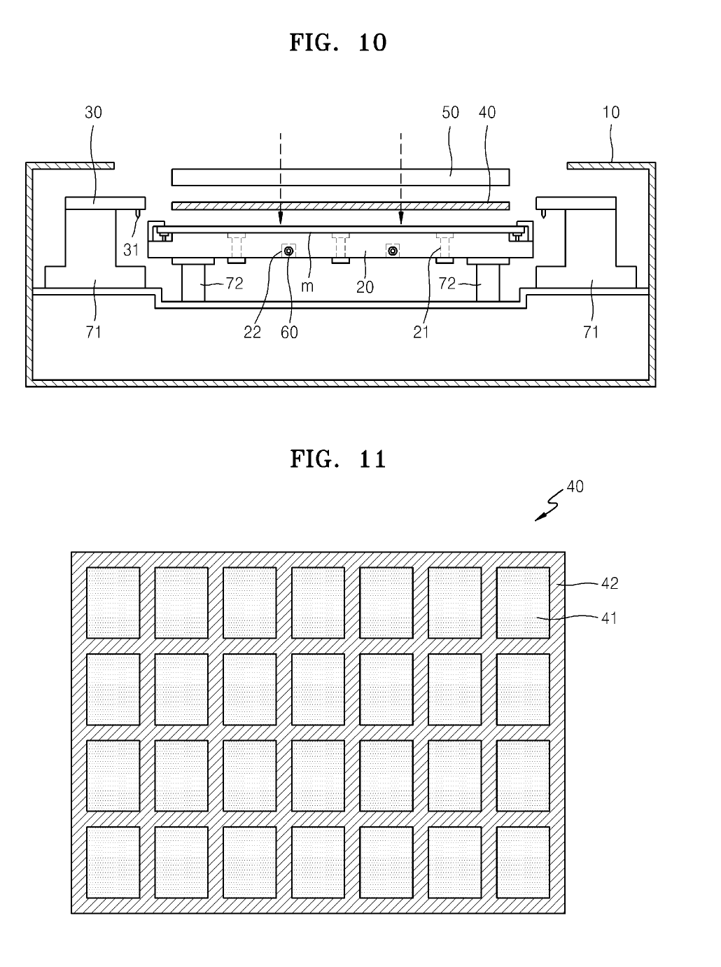

FIGS. 9 and 10 are respectively an oblique view and a side view of a mother substrate testing apparatus, according to an embodiment of the present invention.

Referring to FIGS. 9 and 10, the mother substrate testing apparatus includes a chamber 10, a base plate 20, a signal supply unit 30, and a conducting plate 40. Also, the mother substrate testing apparatus may further include a pressing unit 50, a moving unit 71, a driving unit 72, and a heater 60.

The chamber 10 is a frame that forms an external shape of the mother substrate testing apparatus, and is formed of a firm material. The chamber 10 has an open front surface so as to allow the mother substrate m (refer to FIG. 10) to be freely attached to or detached from the chamber 10. The base plate 20 may be internally disposed at a center of the chamber 10, and the signal supply unit 30 may be internally disposed at a side of the chamber 10. Although not illustrated, a plurality of through holes may be formed at a bottom surface of the chamber 10 so as to easily exhaust heat that is generated at the mother substrate m. When a user tests an organic light-emitting display panel formed on the mother substrate m, the user may slope the chamber 10 toward the ground and then examine it.

The base plate 20 may fix and support the mother substrate m in the chamber 10. The base plate 20 may have a rigidity that is good enough to support the mother substrate m, and may be formed of a material capable of efficiently transferring heat to the mother substrate m. For example, the base plate 20 may be formed of a plate-shape aluminum material. A thickness of the base plate 20 may be adjusted according to a size of the mother substrate m. The base plate 20 may have vacuum pads 21 for attachment of the mother substrate m. The base plate 20 may be disposed on the driving unit 72 and may vertically move according to an operation of the driving unit 72.

The heater 60 transfers heat to the base plate 20. Accordingly, a temperature of all portions of the mother substrate m that is attached to the base plate 20 may be uniformly and efficiently increased in a short time. A total number of the heaters 60 may be adjusted according to a size of the base plate 20, or a type and size of the heater 60. For example, the heater 60 may be formed as an electric heater, and may be inserted into and mounted at each of trenches 22 that are formed at one surface of the base plate 20. Also, the heater 60 may be fixed at the base plate 20 by using a predetermined physical fixing element and fixing method.

The signal supply unit 30 includes a plurality of electrode pins 31, and provides voltages and signals for testing to a test pad (refer to the test pad TP of FIG. 8) of the mother substrate m. The voltages and signals for testing may be used in testing the mother substrate m, and may be generated by a circuit unit (not shown). The circuit unit (not shown) may be formed in the signal supply unit 30 or may be separately formed inside the chamber 10.

The signal supply unit 30 may be disposed at the side of the chamber 10. As illustrated in FIG. 9, the signal supply unit 30 may be disposed at four sides of the chamber 10 but is not limited thereto. That is, the signal supply unit 30 may be disposed at one side or two sides of the chamber 10.

The electrode pins 31 may contact the test pad (refer to the test pad TP of FIG. 8) of the mother substrate m while the electrode pins 31 vertically presses the test pad. Here, each of the electrode pins 31 may have an elastic member having conductivity. Since the electrode pins 31 press the mother substrate m, the mother substrate m may be fixed at the base plate 20, and elasticity of the elastic member included in the electrode pin 31 may form a contact between the electrode pin 31 and the test pad of the mother substrate m.

However, one or more embodiments of the present invention are not limited to the aforementioned structure, and since the base plate 20 having the vacuum pads 21 may firmly fix the mother substrate m, it is acceptable that the electrode pins 31 may horizontally press the mother substrate m, without vertically pressing the mother substrate m.

The signal supply unit 30 may move while the signal supply unit 30 is disposed on the moving unit 71. The signal supply unit 30 may be separated from the base plate 20, and when the mother substrate m is tested, the signal supply unit 30 may move to be adjacent to the base plate 20.

The moving unit 71 is disposed at a side of the chamber 10 and supports the signal supply unit 30. The moving unit 71 may vertically and horizontally move the signal supply unit 30.

The mother substrate testing apparatus includes the conducting plate 40 that contacts a top surface of the mother substrate m. The conducting plate 40 may be formed of a conductive material such as a thin conductive tape. The conducting plate 40 may be used in testing reliability of the mother substrate m. In order to find a progressive dark spot early, the conducting plate 40 may be used in applying an electric field to encapsulation layers that are formed on the display regions AA of the organic light-emitting display panels 100 (refer to FIG. 8). The conducting plate 40 contacts the mother substrate m, and then a bias voltage is applied between the conducting plate 40 and a wiring that is commonly connected with common electrodes (refer to the common electrode 143 of FIG. 1), so that the electric field may be applied to the encapsulation layers of the organic light-emitting display panels 100. Here, a ground voltage may be applied to the conducting plate 40, and a negative bias voltage may be supplied to a wiring that is from among the wirings 181, 182, 191, 192, 193, and 194 (refer to FIG. 8) of the mother substrate m and that is connected with common electrodes of the organic light-emitting display panels 100 via at least one of the electrode pins 31 of the signal supply unit 30. However, the applied voltage is not limited thereto. As long as a predetermined bias voltage may be applied between the conducting plate 40 and the wiring that is connected with common electrodes, voltages that are applied to the conducting plate 40 and the wiring, respectively, may vary.

The mother substrate testing apparatus may further include the pressing unit 50 for pressing the conducting plate 40 so as to allow the conducting plate 40 to be uniformly attached to the top surface of the mother substrate m. The pressing unit 50 may have the same size as the conducting plate 40 and may have a predetermined weight. In the present embodiment, the conducting plate 40 and the pressing unit 50 may be combined with each other.

FIG. 11 is a front view of the conducting plate 40, according to an embodiment of the present invention.

Referring to FIG. 11, the conducting plate 40 may include a plurality of conducting units 41 and an insulating unit 42.

Each of the conducting units 41 may be formed of a conductive material such as metal materials including copper, aluminum, and silver, or a combination of the metal materials. Also, the conducting unit 41 may be formed as a thin-film tape formed of the conductive material. The conducting unit 41 may have a size that corresponds to a size of the display region AA of each of the organic light-emitting display panels 100. When the conducting plate 40 contacts a top surface of the mother substrate m, the conducting units 41 may uniformly contact encapsulation layers (refer to the encapsulation layer 150 of FIG. 1) that are formed on the display regions AA of the organic light-emitting display panels 100.

The insulating unit 42 may be disposed between the conducting units 41 and may have a lattice form. The insulating unit 42 may be formed of an insulation material including plastic. As illustrated in FIG. 8, the first and second wiring groups 180 and 190 for testing may be formed at the boundary regions between the organic light-emitting display panels 100 that are formed at the mother substrate m. The insulating unit 42 may prevent contact between the first and second wiring groups 180 and 190 and the conducting units 41 when the conducting plate 40 contacts the top surface of the mother substrate m.

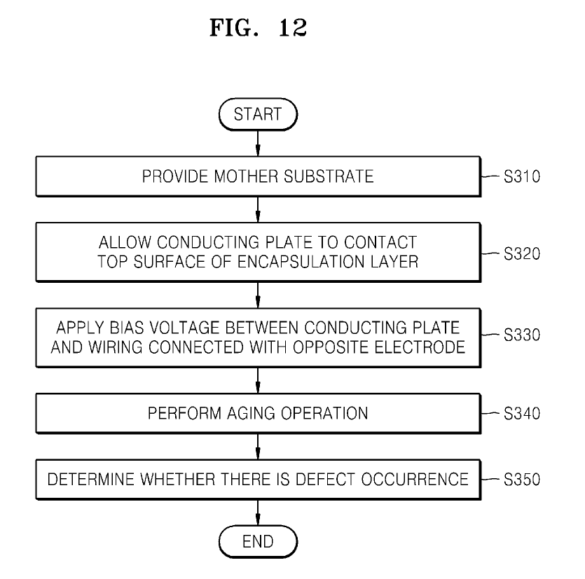

FIG. 12 is a flowchart of a method of testing the organic light-emitting display panel 100, according to another embodiment of the present invention. The method of testing the organic light-emitting display panel 100 according to the present embodiment is related to testing a mother substrate by using the mother substrate testing apparatus of FIGS. 9 and 10.

Referring to FIG. 12, the method of testing the organic light-emitting display panel 100 according to the present embodiment may involve providing the mother substrate m, at which the organic light-emitting display panels 100 are formed, to the base plate 20 (refer to FIG. 9) (operation S310), applying an electric field to encapsulation layers of the organic light-emitting display panels 100 (operations S320 and S330), and determining organic light-emitting display panels that have defects and that are from among the organic light-emitting display panels 100 (operation S350).

First, the mother substrate m is provided to the base plate 20 (operation S310). Then, the mother substrate m is mounted in the base plate 20. Afterward, in order to prevent detachment of the mother substrate m and to tightly attach the mother substrate m to the base plate 20, the mother substrate m may be tightly attached via the vacuum pads 21.

Then, the electric field is applied to the encapsulation layers of the organic light-emitting display panels 100 (operations S320 and S330). In order to apply the electric field to the encapsulation layers of the organic light-emitting display panels 100, the method may allow the conducting plate 40 (refer to FIG. 9) to contact a top surface of the mother substrate m (operation S320), and may allow a bias voltage to be applied between the conducting plate 40 and a wiring that is from among the wirings 181, 182, 191, 192, 193, and 194 (refer to FIG. 8) of the mother substrate m and that is electrically connected to the common electrodes 143 (refer to FIG. 3) of the organic light-emitting display panels 100 (operation S330). In the present embodiment, a ground voltage may be applied to the conducting plate 40, and a negative bias voltage may be applied to the wiring that is connected to the common electrodes 143.

When a predetermined time has elapsed after the electric field is applied, it is determined whether a defect occurs in the organic light-emitting display panels 100 (operation S350). By doing so, any organic light-emitting display panels 100 having a defect such as a dark spot may be found and appropriately dealt with. The organic light-emitting display panels 100 on the mother substrate m may be turned on by applying a lighting signal thereto via the wirings 181, 182, 191, 192, 193, and 194 (refer to FIG. 8) of the mother substrate m, so that the organic light-emitting display panels 100 having the dark spot may be distinguished.

The method of testing the organic light-emitting display panel 100 according to the present embodiment may further involve aging the organic light-emitting display panels 100 (operation S340). The aging operation (operation S340) may be performed after the electric field application (operations S320 and S330). In the aging operation (operation S340), an aging signal may be supplied to the organic light-emitting display panels 100 by using the signal supply unit 30 via the wirings 181, 182, 191, 192, 193, and 194 of the mother substrate m. Accordingly, reliability of the organic light-emitting display panel 100 may be tested in such a manner that an organic light-emitting device in the display region AA is driven during a predetermined time period. The aging operation may be performed when heat is supplied to the base plate 20 (refer to FIG. 9) via the heater 60 (refer to FIG. 10) combined with the base plate 20 so that a temperature of the mother substrate m is increased up to at least 75 degrees, which is significantly higher than a room temperature. If the aging operation is performed under more severe conditions, a time taken to perform the aging operation may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of testing an organic light-emitting display panel, the method comprising:
disposing an electrically conducting plate on an encapsulation layer of the organic light-emitting display panel;
applying a bias voltage across a common electrode of the organic light-emitting display panel and the conducting plate; and
determining whether a defect exists in the organic light-emitting display panel.

2. The method of claim 1, further comprising applying a force against the conducting plate.

3. The method of claim 1, wherein the application of the bias voltage comprises applying a ground voltage to the conducting plate and applying a negative bias voltage to the common electrode.

4. The method of claim 1, wherein the conducting plate comprises a thin-film conductive tape.

5. The method of claim 1, further comprised of aging the organic light-emitting display panel.

6. The method of claim 5, wherein the aging of the organic light-emitting display comprises:
applying heat to the organic light-emitting display panel; and
supplying an aging signal to the organic light-emitting display panel.

7. The method of claim 1, wherein the determining of the defect comprises:
turning on the organic light-emitting display panel; and
checking whether a dark spot occurs among images provided by the organic light-emitting display panel.

8. The method of claim 1, wherein the encapsulation layer is a thin film encapsulation (TFE) layer.

9. A mother substrate testing apparatus for testing a mother substrate on which a plurality of organic light-emitting display panels are formed, the mother substrate testing apparatus comprising:
a base plate bearing the mother substrate;
a signal supply unit comprising a plurality of electrode pins, and providing electric signals to a pad unit of the mother substrate; and
an electrically conducting plate contacting a top surface of the mother substrate,
a bias voltage supplied to the mother substrate via at least one electrode pin of the plurality of electrode pins and the conducting plate so as to apply an electric field to encapsulation layers of the plurality of organic light-emitting display panels.

10. The mother substrate testing apparatus of claim 9, wherein the conducting plate is connected to a ground voltage source.

11. The mother substrate testing apparatus of claim 9, wherein the at least one electrode pin provides a negative bias voltage to a wiring that is commonly connected to common electrodes of the plurality of organic light-emitting display panels.

12. The mother substrate testing apparatus of claim 9, wherein the conducting plate comprises a thin-film conductive tape.

13. The mother substrate testing apparatus of claim 9, wherein the conducting plate comprises:
a plurality of conducting units that correspond to display units of the plurality of organic light-emitting display panels; and
an insulating unit that is disposed between the plurality of conducting units and has a lattice form.

14. The mother substrate testing apparatus of claim 9, further comprising a pressing unit that presses the conducting plate so as to allow the conducting plate to be tightly attached to the encapsulation layers.

15. The mother substrate testing apparatus of claim 9, wherein, after the bias voltage is supplied, voltages are supplied to the mother substrate via the plurality of electrode pins so as to age the plurality of organic light-emitting display panels.

16. The mother substrate testing apparatus of claim 9, further comprising a heater that is combined with the base plate and that provides heat to the mother substrate.

17. A method of testing a mother substrate, the method comprising:
providing the mother substrate, on which a plurality of organic light-emitting display panels are formed, to a base plate;
disposing a conducting plate on encapsulation layers of the organic light-emitting display panels;
applying a bias voltage between the conducting plate and a wiring that is from among wirings of the mother substrate and that is electrically connected with common electrodes of the plurality of organic light-emitting display panels; and
determining organic light-emitting display panels having a defect from among the plurality of organic light-emitting display panels.

18. The method of claim 17, further comprising applying a force against the conducting plate.

19. The method of claim 17, further comprising aging the plurality of organic light-emitting display panels.

20. The method of claim 19, wherein the aging comprises:
supplying heat to the base plate via a heater that is combined with the base plate; and
providing an aging signal to the plurality of organic light-emitting display panels.
